(19) United States
(12) Patent Application Publication
(10) Pub. No.: US 2014/0223086 A1
(43) Pub. Date: Aug. 7, 2014

(54) RAPID READING FROM MEMORY DEVICES

(71) Applicant: CURIOSITATE, INC., Cambridge, MA (US)

(72) Inventor: Elan Y. Pavlov, Cambridge, MA (US)

(73) Assignee: CURIOSITATE, INC., Cambridge, MA (US)

(21) Appl. No.: 14/172,470

(22) Filed: Feb. 4, 2014

Related U.S. Application Data
(60) Provisional application No. 61/761,466, filed on Feb. 6, 2013.

(51) Int. Cl. G06F 13/16; G06F 12/02

(52) U.S. Cl. CPC G06F 13/1657; G06F 12/0246
USPC 711/103; 711/151

(57) ABSTRACT

The invention generally relates to rapid reading of data from multi-level cell (MLC) memory devices. Information is stored in a way that allows all of the bit-space to be used but that also allows single-read-per-cell retrieval. Data is triaged into high priority data and low priority data. The high priority data is then stored in an MLC memory device with one bit per cell. This data can them be read from the MLC cells by one comparison operation on each cell, accomplishing all of the required read operations in parallel in the time it takes to perform a single comparison. Low priority data is stored in the remaining bit-space of the cells, to take full advantage of all of the available bit-space of the cells.

### CROSS-REFERENCE TO RELATED APPLICATION

This application claims the benefit of, and priority to, U.S. Provisional Application Ser. No. 61/761,466, filed Feb. 6, 2013, the contents of which are incorporated by reference.

### FIELD OF THE INVENTION

The invention generally relates to rapid-read multi-level cell memory devices.

### BACKGROUND

Memory devices such as flash memory operate by storing bits of information in cells. In the case of flash memory, for example, information is stored in a cell as charge stored in a floating gate transistor. In single-level cell (SLC) devices, each cell stores one bit. In multi-level cell (MLC) devices, a number of bits of data are stored in each cell. Storing information involves storing a quantity of charge, which can be read and referred to as a voltage. Reading the information back involves estimating the set voltage. Other methods of storing data include storing it as resistance (in a memristor), current (for storing volatile data), thermo-electricity, or other techniques this is in contrast to U.S. Publication 2012/0290768 to Rubowitz in which the storage medium is limited to flash memory . While MLC devices appear to offer the potential to store more information per cell than SLC devices, this is at the expense of speed.

In existing MLC devices, reading information bogs down and goes slowly due to the way in which stored data is read. Using flash as an example, where two bits of information might be stored as a single voltage that varies from 0 to 1, the bit values 00, 01, 10, and 11 may be stored as 0.125 V, 0.375 V, 0.625 V, and 0.875 V, respectively. Since reading can only proceed by a binary comparison, it requires two sequential read operations to determine the stored bit value. For example, the stored voltage is first compared to 0.5 V. If the stored value is lower (or higher) than 0.5 V, it is then compared to 0.25 V (or 0.75 V). The result of the sequential comparisons gives the unique voltage and thus the two bit value, but it also requires twice as much time as reading from a SLC device. The more bits per cell, the longer the read time.

### SUMMARY OF THE INVENTION

The invention provides systems and methods for reading information from MLC memory cells that require only a single binary comparison per cell. Information is stored in a way that allows all of the bit-space to be used but that also allows single-read-per-cell retrieval. This involves triaging data to be stored into high priority data and low priority data. The high priority data is then stored in an MLC memory device with one bit per cell. This data can then be read from the MLC cells by one comparison operation on each cell, accomplishing all of the required read operations in parallel in the time it takes to perform a single comparison. Low priority data is stored in the remaining bit-space of the cells, potentially taking full advantage of all of the available bit-space of the cells. The bits are stored in the cells in such a way that a single comparison operation on any cell reveals the high priority bit that is stored there. Low priority bits are retrieved by conventional sequential comparison operations. Systems and methods of the invention employ any of a variety of strategies to characterize data to be stored as high priority or low priority. A data set, such as a file or a numerical balance, that is stored as high priority bits is retrieved in its entirety by reading all of the cells where those bits are stored and reading each of those cells with a single comparison operation. Since all of the comparison operations can be performed simultaneously, the high priority data set is retrieved very rapidly. Additionally, the speed of retrieval does not depend on the number of bits per cell. Thus, emerging memory technologies can increase the number of bits of information stored in MLC memory cells and data can be read from those device very rapidly.

In certain aspects, the invention provides a device for storing information. The device includes a bus with an interface for communication with a computer processor, storage cells connected to the bus, and a control system. The control system is operable to store high priority information and low priority information in the plurality of cells and retrieve all of the high priority information by performing a single read operation, such as a comparison, on each cell at the same time. The control system may store both high priority information and low priority information in each of the plurality of cells. Whereas some prior art uses only a single disk, methods of the invention may treat a single physical disk as multiple virtual disks. Such disks can differ in properties such as size, speed of reading and number of usable duty cycles.

In some embodiments, the device is a flash memory device and each cell includes a metal oxide field effect transistor. The control system may include a NAND driver, NAND control chip, or both. In certain embodiments, the device is a USB storage device.

In some embodiments, the control system is operable to store the high priority information by reading the low priority information from the plurality of cells, then erasing the plurality of cells, and then storing the high priority information and the low priority information in the plurality of cells. The control system may store the high priority information at one bit per cell in each of the plurality of cells.

In related aspects, the invention provides a method of storing data in a tangible medium. The method includes receiving a set of bits, storing each bit of the set of bits within a tangible storage medium in one of a plurality of cells, and storing a second set of bits in the plurality of cells. In some embodiments, the set of bits comprises part of a single digital file.

Preferably, the tangible storage medium includes a solid state electronic device (e.g., in which each cell uses a metal oxide field effect transistor). The method can further include obtaining the second set of bits from the plurality of cells and erasing the plurality of cells. The obtaining and erasing steps may occur after the receiving step and prior to the storing steps.

Aspects of the invention provide a method of writing to an array of multi-level cells by receiving a plurality of high priority bit values, reading a plurality of low-priority bit values stored as analog values in a plurality of cells, encoding the high priority bit values and the low priority bit values as a plurality of new analog values, and storing the plurality of new analog values in the plurality of cells with one high priority bit value per cell.

In certain aspects, the invention provides a method of storing data in a tangible medium that proceeds by obtaining a first value for a first bit and a second value for a second bit and setting a cell voltage. If the first value is 1 and the second value is 0, the voltage is above a first threshold value and below a second threshold value. If the first value is 1 and the second value is 1, the voltage is above the first threshold value and above the second threshold value. If the first value is 0 and the second value is 0, the voltage is below the first threshold value and below and alternative second threshold value. If the first value is 0 and the second value is 1, the voltage is below the first threshold value and above the alternative second threshold value.

In other aspects, the invention provides a method of marking areas of the storage medium as being unusable. Current technology marks a sector as being unusable when it has been used a certain number of times or when there is a fixed amount of voltage leakage. The method allows some parts of a storage cell (e.g., the low value bits) to be marked as unusable while other parts of the same storage cell (e.g., the higher value bits) to be continued to be used.

In certain aspects, the invention provides a method of storing data in a tangible medium, the method comprising: obtaining a first value for a first bit and a second value for a second bit and setting a cell voltage so that: if the first value is 1 and the second value is 0, the voltage is above a first threshold value and below a second threshold value; if the first value is 1 and the second value is 1, the voltage is above the first threshold value and above the second threshold value; if the first value is 0 and the second value is 0, the voltage is below the first threshold value and below and alternative second threshold value; and if the first value is 0 and the second value is 1, the voltage is below the first threshold value and above the alternative second threshold value.

### BRIEF DESCRIPTION OF THE DRAWINGS

FIG. 1 shows a field effect transistor.

FIG. 2 is a diagram of a metal oxide semiconductor field effect transistor.

FIG. 3 gives a high-level diagram of a fast-read memory system.

FIG. 4 depicts an exemplary memory chip.

FIG. 5 represents a USB flash storage device.

FIG. 6 illustrates a prior art way of reading data.

FIG. 7 reveals a rapid method of reading data.

FIG. 8 exemplifies methods of establishing data priority.

FIG. 9 shows a method of writing data for high-speed reading.

### DETAILED DESCRIPTION

The invention provides methods and devices for storing bits of information. Information has a binary structure and is stored in cells that record analog values. Herein, cell values are treated as varying from 0 to 1, but it will be appreciated that this is an arbitrary scale and the actual numerical values will depend on the medium and context. Methods of the invention are operable with any device that stores information as analog values in cells with more than one bit per cell. In a preferred embodiment, the invention provides methods and devices for computer memory. In some embodiments, the invention provides flash memory devices and methods of use thereof.

Flash memory is a computer storage medium that can be electrically erased and reprogrammed. There are two main types of flash memory, which are named after the NAND and NOR logic gates. Additional technologies are being developed such as magneto-resistive random access memory, or MRAM. Flash memory stores bits of information in cells, as is discussed in much greater detail below. For the purposes of this disclosure, the values as stored in those cells are considered to be analog (e.g., potentially varying continually from 0 to 1), even if used with a device in which individual charge carriers could be counted. In contrast to the analog nature of cell values, information is quantized into binary units called bits.

A bit can have a value of 1 or 0, where 1 could be referred to as “on” or “set” and 0 could be referred to as “off” or “cleared”. Eight bits together form a byte and are sometimes written as, e.g., 00110101b (or sometimes %00110101), where ‘b’ stands for binary.

Bits of information can be stored by encoding them as analog values in individual cells within a memory device. Memory devices of the invention have a plurality of cells and each cell is capable of storing a plurality of bits as an analog value. In some embodiments, a memory device of the invention is a flash memory device, and each cell includes a transistor that is used to store an analog value. A transistor is a semiconductor device that can be used to amplify or switch electronic signals. A transistor can use a small signal applied between one pair of its terminals to control a much larger signal at another pair of terminals. This property is called gain. There are two types of transistors: bipolar transistors—with terminals labeled base, collector, and emitter—and field effect transistors. For a field-effect transistor, the terminals are labeled gate, source, and drain, and a voltage at the gate can control a current between source and drain.

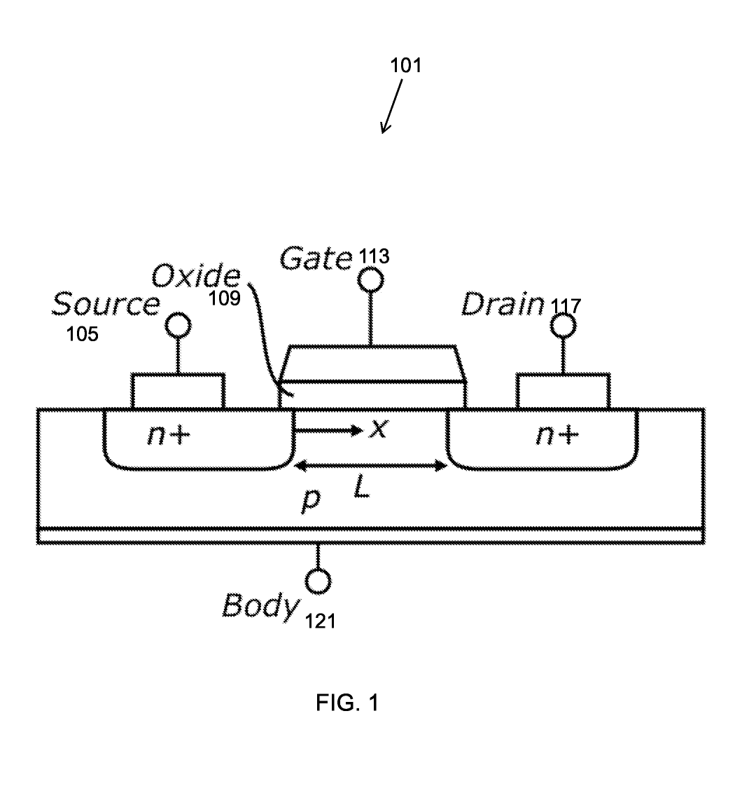

FIG. 1 gives a very high level diagram of some elements of a field effect transistor 101. Transistor 101 includes a semiconductor material with at least three terminals for connection to an external circuit. A voltage or current applied to gate 113 and body 121 changes the current flowing from source 105 to drain 117. Because the controlled (output) power can be higher than the controlling (input) power, a transistor can amplify a signal. The applied voltage creates an electric field that penetrates into the semiconductor material, affecting the conductivity of the material and the mobility of the charge carriers. Accordingly, transistor 101 is an example of a field effect transistor. The field effect underlies the operation of the Schottky diode and of field-effect transistors, notably the MOSFET, the JFET and the MESFET. see, for example, M K Achuthan K N Bhat (2007). “Chapter 10: Metal semiconductor contacts: Metal semiconductor and junction field effect transistors”. Fundamentals of semiconductor devices. Tata McGraw-Hill. pp. 475.

In erasable programmable computer memory devices (EPROM) such as flash memory, each memory cell resembles a standard MOSFET, except the transistor has two gates instead of one. One of the transistors is known as a floating gate, and the other one is the control gate.

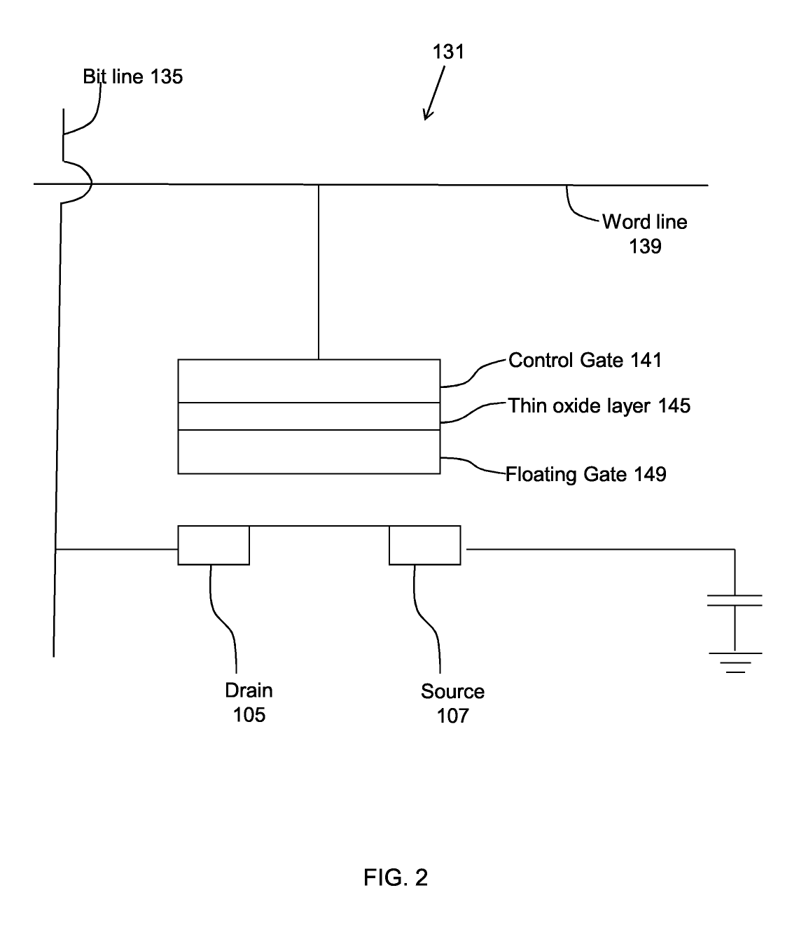

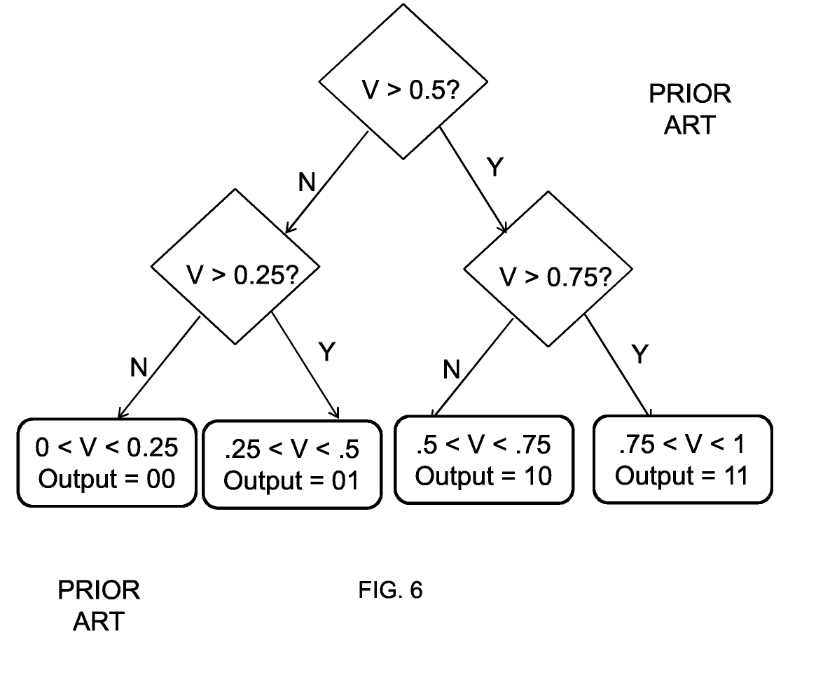

FIG. 2 depicts a floating gate transistor 131 as deployed in an EPROM device. Flash memory is type of EPROM devices that employs a grid of cells that each include a floating gate transistor 131. On top is the control gate 141, as in other MOS transistors, but below this there is a floating gate 149 insulated all around by an oxide layer. Floating gate 149 is interposed between control gate 141 and the MOSFET channel (e.g., between source 107 and drain 105). Because floating gate 149 is electrically isolated by its insulating layer, any electrons placed on it are trapped there and, under normal conditions, will not discharge for many years. Thus, a device of the invention can be a tangible, non-transitory computer readable medium. When floating gate 149 holds a charge, it screens (partially cancels) the electric field from control gate 141, which modifies the threshold voltage (VT) of the cell (more voltage has to be applied to control gate 141 to make the channel conduct). For read-out, a voltage intermediate between the possible threshold voltages is applied to the control gate, and the MOSFET channel's conductivity tested (if it's conducting or insulating), which is influenced by floating gate 149. The current flow through the MOSFET channel is sensed and forms a binary code, reproducing the stored data. In a multi-level cell device, which stores more than one bit per cell, reading all of the bits requires a series of binary comparisons (discussed below with respect to FIG. 6).

Flash comes in two types, NOR and NAND.

In NOR gate flash, each cell has one end connected directly to ground, and the other end connected directly to bit line 135. This arrangement is called “NOR flash” because it acts like a NOR gate: when one of the word lines 139 (connected to the cell's control gate 141) is brought high, the corresponding storage transistor acts to pull the output bit line 135 low. NOR Flash is useful for embedded applications requiring a discrete non-volatile memory device.

A single-level NOR flash cell in its default state is logically equivalent to a binary “0” value, because current will flow through the channel under application of an appropriate voltage to the control gate, so that the voltage of bit line 135 is pulled down. A NOR flash cell can be programmed, or set to a binary “1” value, by applying a voltage to control gate 141, which turns the channel on (e.g., by the field effect), allowing electrons to flow from source 107 to drain 105. This source-drain current is sufficiently high to cause some high energy electrons to jump (“tunnel”) through the insulating layer onto floating gate 149, via a process called hot-electron injection, or tunneling.

To erase a NOR flash cell (resetting it to the “0” state), a large voltage of the opposite polarity is applied between control gate 141 and source terminal, pulling the electrons off floating gate 149 through quantum tunneling. Modern NOR flash memory chips are divided into erase segments (often called blocks or sectors). Flash memory uses in-circuit wiring to apply the electric field either to the entire chip or to predetermined sections known as blocks. This erases the targeted area of the chip, which can then be rewritten. Flash memory can work much faster than traditional EEPROM by erasing a block or entire chip in a single operation.

NAND flash also uses floating-gate transistors, but with several transistors connected in series. If all word lines 139 are pulled high (above the transistors' threshold) then the bit line 135 is pulled low. These groups are then connected via some additional transistors to a NOR-style bit line array in the same way that single transistors are linked in NOR flash. To read, the desired group is selected and most of the word lines 139 are pulled up above the VT of a programmed bit, while one of them is pulled up to just over the VT of an erased bit. The series group will conduct (and pull the bit line 135 low) if the selected bit has not been programmed.

NAND flash uses tunnel injection for writing and tunnel release for erasing. NAND flash memory can provide the core of the removable USB storage devices as well as other card formats and solid-state drives.

In some embodiments, flash chips 185 are operated by a general purposes CPU (e.g., without a dedicated controller chip). For example, a memory device may be made to include a plane electrode connected to a flash-memory chip by bonding wires. The flash-memory chip, plane electrode and bonding wires are embedded in a resin by over-molded thin package (OMTP) and this module is glued to a base to create a card. This card is operable to be inserted into a device and controlled by the device (e.g., by the processor of the device). In certain embodiments, a memory device of the invention includes one or more flash memory chips and a dedicated controller chip.

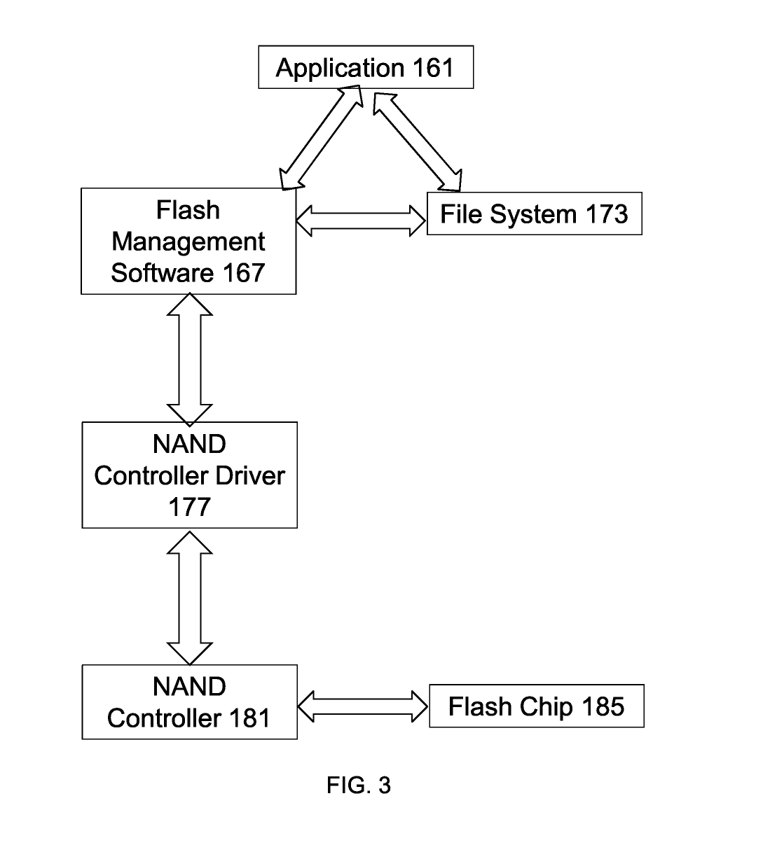

FIG. 3 gives a diagram of functional components of a flash memory system. The array of cells is provided by flash chip 185. The current that operates chip 185 is controlled by flash controller 181. A computer system may include a controller driver 177 that allows the software of the computer system to “talk to” flash controller 181. Flash management software 167 is included to perform various functions, such as the triaging or encoding function discussed herein. Flash management software 167 interoperates with file system 173 and one or more computer application 161 to provide computer memory functionality to a user. Typically, a flash memory device will adhere to standards developed by the Personal Computer Memory Card International Association (PCMCIA).

A NAND memory device may include a mechanism for bad block management provided by controller driver 177 or controller chip 181. SD cards, for example, include controller circuitry to perform bad block management and wear leveling. When a logical block is accessed by high-level software, it is mapped to a physical block by controller driver 177 or controller chip 181.

Controller chip 181 manages the data stored on flash chip(s) 185 and communicates with a computer or electronic device.

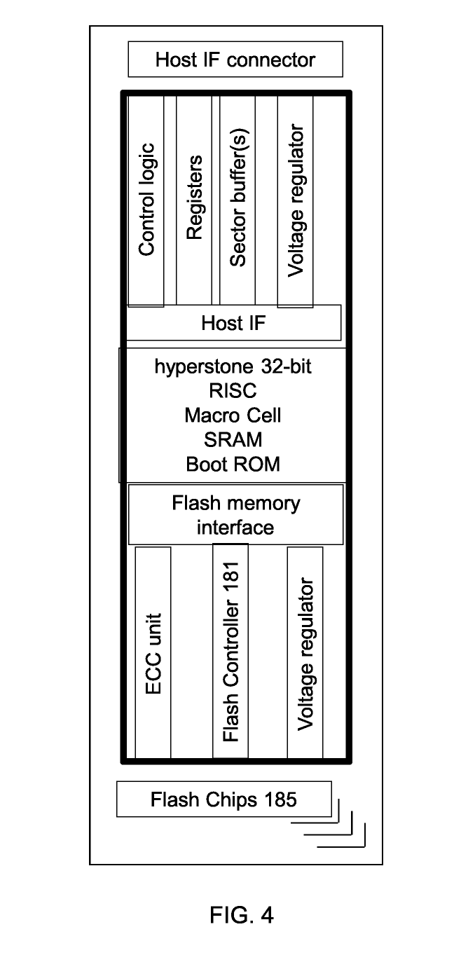

FIG. 4 is a generic block diagram of an exemplary controller chip 181. Controller chip 181 can operate in devices such as SD cards, CompactFlash cards, or other similar media for use in digital cameras, PDAs, mobile phones, etc. USB flash drives use flash memory controllers designed to communicate with personal computers through the USB port at a low duty-cycle. Flash controllers can also be designed for higher duty-cycle environments like solid-state drives (SSD) used as data storage for laptop computer systems clear up to mission-critical enterprise storage arrays. Controller chip 181 can include the 32-Bit RISCi CPUii from Hyperstone GmbH (Konstanz, Germany) together with dedicated hardware blocks, including an error correcting code (ECC) unit, buffers, flash and host interface control logic.

After a flash storage device is initially manufactured, controller chip 181 can be used to first format flash chip 185. Controller chip 181 can map out bad flash memory cells, allocate spare cells to be substituted for future failed cells, or perform other functions. Some part of the spare cells is also used to hold the firmware which operates the controller and other special features for a particular storage device. A directory structure is created to allow the controller to convert requests for logical sectors into the physical locations on the actual flash memory chips.

When the system or device needs to read data from or write data to the flash memory, it will communicate with the flash memory controller 181. Simpler devices like SD cards and USB flash drives typically have a small number of flash memory die connected simultaneously.

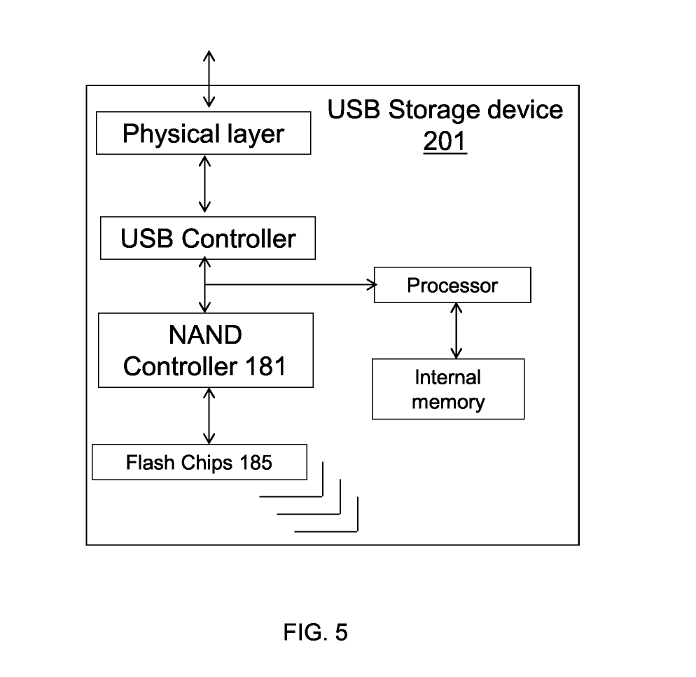

FIG. 5 diagrams a USB flash drive. Data goes through a USB controller, and a USB controller manages data flow, sets parameters of data transmission for NANDFLASH-CTRL, controls the USB, and handles all aspects connected with a File System implemented within this storage device.

NAND controller 181 can be provided by any suitable chip such as the GBDriver RS4 Series with 3 Gb/s SATA from TDK Corporation (Tokyo, Japan) or the CADENCE NAND flash controller, sold by Cadence Design Systems (Berkshire, UK).

Flash chip(s) 185 can be provided in a variety of integrated circuit packages with different numbers of pins and flip-flops. Basic package types include ball grid array (BGA), quad flat package (QFP), single in-line package (SIP), and dual in-line package (DIP). Many packaging variants are available. For example, BGA variants include plastic-ball grid array (PBGA) and tape-ball grid array (TBGA). QFP variants include low-profile quad flat package (LQFP) and thin quad flat package (TQFP). DIPs are available in either ceramic (CDIP) or plastic (PDIP). Other IC package types include small outline package (SOP), thin small outline package (TSOP), and shrink small outline package (SSOP). Flash chip 185 can be any suitable chip such as, for example, the 64GB eMMC Pro Class 2000 by Samsung (Seoul, South Korea), the 20 nm 128 Gb NAND devices from Micron (Boise, Ind.), or the 128 Gb NAND chip from SanDisk Corporation (Milpitas, Calif.).

Flash memory chips can be packaged with controllers and circuitry on a PCB and offered as a “hard drive” or SSD for use in computers as offered, for example, by Micron (Boise, Ind.) and Crucial (Meridian, Ind.).

Use of controller 181 not only reduces the CPU load on the device, which has the effect of increasing battery life as well as increasing performance, but is particularly beneficial in MLC devices, which benefit from good error detection algorithms.

Controller chip 181, driver 177, flash management software 167, a general purpose microprocessor, or a combination thereof can be configured to implement the reading and writing methodologies provided by the invention.

The measurement process used to read values stored in a storage device is important for the capacity and speed of the device. For example, the capacity of a storage cell is directly related to the error expected in its measurement. As the measurement process becomes more accurate, the number of bits which can be stored in a cell increases.

In addition, the more accuracy is required, the longer it takes to achieve that accuracy. This is often due to settling time of the measurement instrument, or the search time it takes to achieve the desired accuracy. Settling time is generally inversely related to the degree of accuracy needed for a measurement, so for instance the measuring the highest-order bit in a k-bit comparison is faster than measuring the lower-order bits.

Unlike U.S. Publication 2012/0290768 to Rubowitz which merely relates to access time, systems and methods of the invention may be used to address and improve the number of duty cycles that a storage device can utilize. The invention includes the insight that the level of accuracy required for a measurement influences how many duty cycles the flash memory can be used for. Multiple write cycles with flash memory leads to degradation of the ability to distinguish different voltages. If the required accuracy of voltage is lower the memory can be used for more write cycles. If different bits in a cell have different levels of required accuracy, additional write cycles can be utilized on the bits requiring lower levels of accuracy.

Thus by utilizing this invention, we can increase the total number of duty cycles a storage device can undergo. For example, the higher level bits (or the virtual disk corresponding to the higher level bits) can undergo more duty cycles than the lower level bits (or the virtual disk corresponding to the lower level bits). The difference in duty cycles can be quite significant. For example a factor of 5 in available duty cycles between SLC and triple-level cells (TLC) or MLC is quite common. Discussion of SLC, TLC, and MLC is found in U.S. Pat. 8,634,243 to Lin and in U.S. Pub. 2012/0033492 to Chen, the contents of each of which are incorporated by reference for all purposes.

Devices and methods of the invention employ novel ways of storing and reading bits of data. Bits are read using a comparator that compares the cell voltage to a series of threshold voltages. Essentially, the primitive which is used to measure the voltage is a comparator or slicer. What the comparator checks if the voltage measured is greater or smaller than a fixed voltage. For SLC a single comparison is utilized. If the voltage is above a preset value the value of the cell is considered to be one else it is considered to be zero (in practice there is often a buffer between the high voltage and the low voltage which denotes that we are not sure of the output).

Prior art devices suffered from limited speed and fewer write cycles. FIG. 6 gives a diagram of a prior art method of reading information from an MLC flash device. The serialized data interface to NAND has presented a difficult scenario for transferring data in and out of the chip. In prior art flash memories, data from a single source is written across a block of cells, and data within any given cell comes from a single source. As a result, in order to read out data from any source, a k-bit comparison is carried out for each of those cells. FIG. 6 shows a prior art cell storing 4 bits. Reading requires a binary search to discover the value of the voltage. In a voltage-based cell storing k bits, the voltage is converted to its binary representation, where 0.0000 . . . (k bits long) corresponds to the lowest voltage and 0.1111 . . . (k bits long) corresponds to the maximal voltage. The value of the cell is the bits of the readout in binary representation. For example, the value 0.10111 corresponds to the 5-bits 10111. Prior art devices required at least k measurements to read out fully. For example, for k=2, the two-bit sequences (00, 01, 10, 11) map to voltages {0.125 V, 0.375 V, 0.625 V, 0.875 V} as shown in FIG. 6. In prior art devices, reading is done by comparing along a binary tree as shown in FIG. 6. The voltage is first compared to 0.5 V. If the voltage is higher than 0.5 V, it is then compared to 0.75 V. Values above 0.75 correlate to the bit value 11. Values less than 0.75 V (but higher than 0.5 V) correlate to the bit value 10. However, if the value is below 0.5 V, it is compared to 0.25 V, and so on. For larger numbers of bits per cell, more and more steps are involved.

The invention employs the insight that, even where a cell stores many bits, the first comparison retrieves one bit. Further, the invention includes the insight that data to be written in memory includes a variety of different contents (e.g., system files, user files, songs, bank balances, HTML pages, etc., without limit) and that these different contents can be partitioned into a high priority category and into one or more low priority categories.

Note that certain representations shown herein are chosen for convenience of exposition.

In general many representations can extract one bit of data from each measurement. This method can be used even when different levels of precision are used for different bits, or when multiple measurements are needed for a single bit.

In practice, data sources typically are larger than a single cell. Writing and reading involves acting on multiple cells in parallel, and combining the result. Similarly, large amounts of data are written to many cells in parallel.

Using systems and methods of the invention, the k bits of a high priority information item are stored across k cells, and the reading comparisons are done in parallel.

The invention further includes the insight that data often follows a power law in which the most heavily accessed data is utilized much more than the least accessed and that this relationship has useful applications in memory.

The invention provides storage and reading methods in which high-priority data is stored in the highest-order bits of each cell, both allowing faster parallel processing of the data and making the individual reads of those bits faster.

Using, for example, a hypothetical piece of information that has been recognized as high priority and that consists of 100 bits, storing this information involves allocating one bit to each of 100 cells. Reading this information from the device involves reading all 100 bits in parallel in the time it takes to make 1 comparison. This may give a 4×improvement in speed compared to a 4 bit prior art device, a factor that increases as the number of bits in the cell increases.

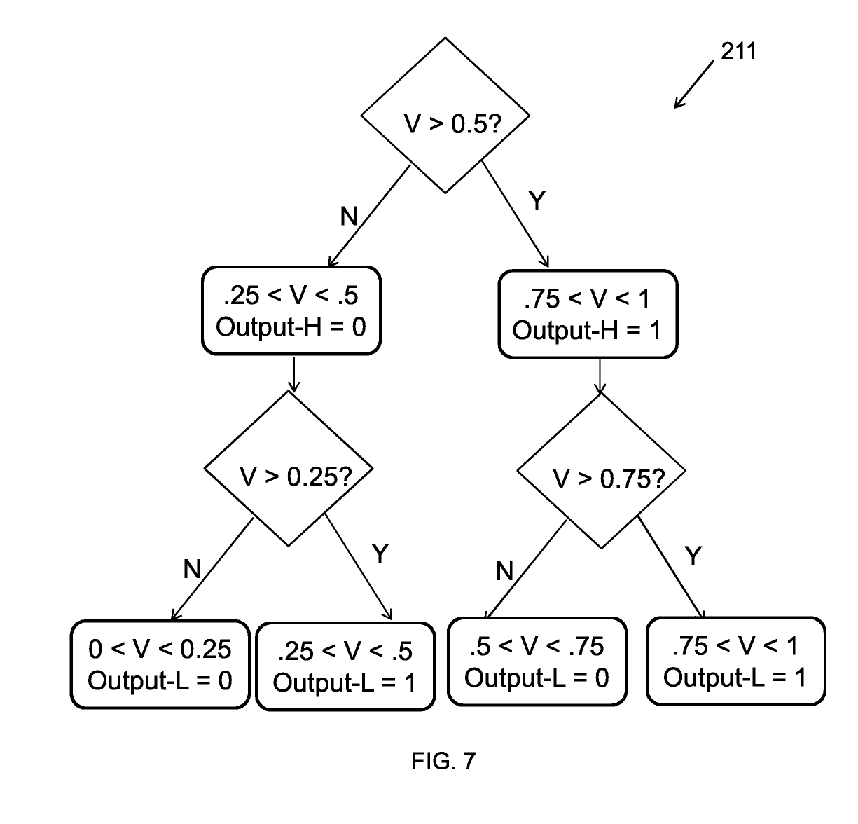

FIG. 7 gives a diagram of a method of reading once cell. In the diagrammed method, the high priority bit is fully read on the first comparison. A second or subsequent comparison is only made if the controller has requested reading a low priority bit that is also stored in the cell.

By storing both low and high priority bits in the cells, space is used most efficiently. A primary purpose of adding levels in MLC is to increase total storage capacity. Here, the low priority bits are allocated to a different source (or the same source, but a part of it which is less used or requires less speed for other reasons).

In addition, the uses of both high and low priority bits in the cell allow the high priority bits to be written after the required fidelity for low priority bits is no longer present.

Sources or blocks of data can be tracked in a most-often-read queue, with the top sources stored in high-priority bits. For example, a special block on the SSD can be used for this.

In one hypothetical example, a system has 4 bit cells. A high priority data source contains the 8 bits 01001001, and low-priority data source contains the 15 bits: 000000110100111001011001.

Together, this represents 32 bits that require 8 cells for storage. The bits are allocated to the cells as follows. The first bit will be from the high priority data, with the low priority data getting the other 3 bits per cell. The low-priority source is separated into sets of 3 bits as follows:

000 000 110 100 111 001 011 001.

This is then stored in the cells as follows:

1. Cell 1: 0(000)

2. Cell 2: 1(000)

3. Cell 3: 0(110)

4. Cell 4: 0(100)

5. Cell 5: 1(111)

6. Cell 6: 0(001)

7. Cell 7: 0(011)

8. Cell 8: 1(001)

Reading the high priority data requires a single comparison from each cell, while reading the low priority data requires 4 sequential comparisons from each cell.

Devices and methods of the invention categorize data as high priority, low priority, and optionally into other categories as well. Data can be prioritized by any suitable method such as, for example, keeping track of which files are accessed often, marking some files as a priori being important, referring to a need for speed, referring to an inherent importance of the data, other methods, or a combination thereof. In some embodiments, algorithms are used which are e.g., used in assigning data to memory as opposed to disk. Alternatively or additionally algorithms which assign priority such as algorithms which decide which files go on tape drives versus hard drives may be used. Any suitable method of prioritizing data will work.

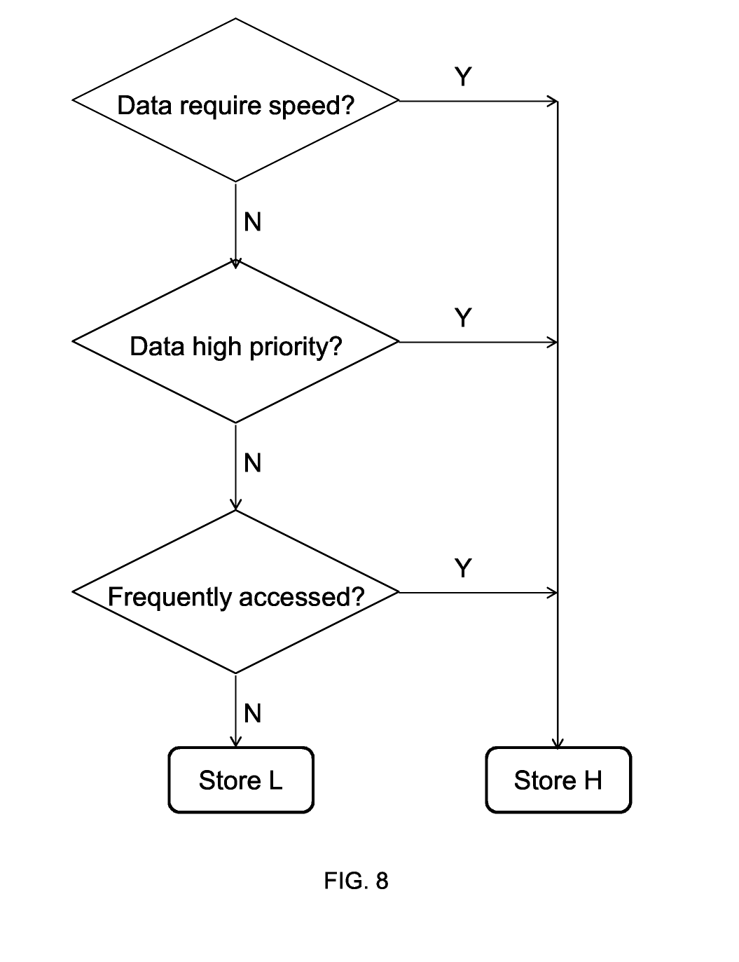

FIG. 8 illustrates a method of prioritizing data. First, it is ascertained if the data is of a type that requires speed. For example, some computer games that depict rapidly changing environments may “tag” certain data as needing to be rapidly accessed later. Such data could be taken as high priority data. Second, the extrinsic importance or priority of the data is evaluated. For example, a business may set present financial balances to be high priority, and may deem ten-year-old archives of duplicate receipts to be low priority. Finally, frequency of access could be assessed (e.g., according to a simple threshold such as “daily” or “every second”). If any of these criteria are met, the data is deemed high priority and is stored one bit per cell.

In addition to needing to use only a single pass of the comparator, there are additional advantages to this system. First, the speed of reading bits which have high voltages differences is much faster than the use of a comparator for low voltage differences (such as are present in bits with lower significant values). This means that the actual speed improvement is larger than was described above. Another advantage is that the power usage to read bits can be made proportional to the difference in voltage. This results in lower power usage and less heat generated which contribute substantial savings in many settings. Since SLC requires less power to read than MLC to read, we can read the high priority bits using SLC power while reading the lower priority bits using the higher power levels associated with MLC. Unlike the prior art, the invention provides that different power levels can be used for high priority bits as opposed to low priority bits. This saves on the cost of power, reduces battery size and reduces heat.

Additionally, we are no longer required to mark an entire cell as being un-writeable but can merely mark the low priority bits as being un-writeable while continuing to utilize the high priority bits.

The invention provides devices and methods for writing data that can be read in the time of a single pass of the comparator. Since writing a bit of high priority data may require erasing and re-writing one or more bits of un-related low priority data, writing involves a read operation.

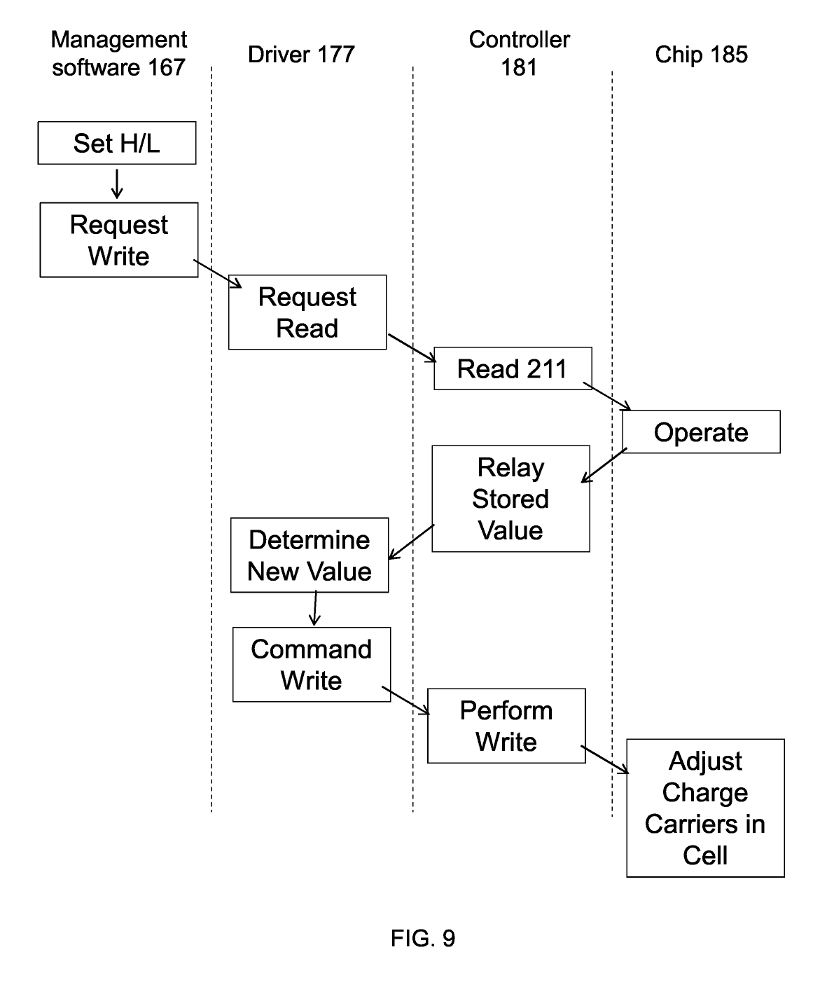

FIG. 9 gives a diagram of writing according to certain embodiments. Software 167 determines that some data is either high or low priority and requests that it be written. Driver 177 first requests a read operation. Controller 181 executes a read operation. Controller 181 may read an entire physical cell/block. Note that if we are e.g., writing the least significant bits we do not need to read the whole block. In general we only need to read the data which is not the data being written.

Controller 181 can relay the value back to driver 177 which can calculate the values of the bits in the cell. This depend on the new value being written as well as by the value of the other data stored in the cell. Finally, controller 181 is called upon to write the entire physical block.

It is also possible to optimize the read for bits of lower significance. The key is to have relatively large ranges of voltages for which the value of the low priority bit does not change.

Currently, the high priority bit takes one clock tick and the low priority bit takes two clock ticks. Therefore, a different coding than the standard encoding can be used. For example:

0-0.25 is 00

0.25-0.5 is 01

0.5-0.75 is 11

0.75-1 is 10

(The difference is that the last two values are swapped from the usual encoding).

Note that in this case, the high priority bit is read in a single clock tick as before. For the low priority bit, note that the values of the low priority bit can be in one of three ranges.

If the voltage is less than 0.25 the low priority bit is 0.

If the voltage is between 0.25-0.75 the low priority bit is 1.

If the voltage is higher than 0.75 the low priority bit is 0.

Note that this means that the number of possibilities for the low priority bit in this encoding is 3 as opposed to the usual 4 (0-0.25 is 0, 0.25-0.5 is 1, 0.5-0.75 is 0 and 0.75-1 is 1). Therefore, the number of comparisons needed to read the low priority bit is less than 2.

For example, a method of reading can include the following:

Compare to 0.25. If it is less than the value of the low priority bit is 0 and we can terminate. This happens with probability 0.25.

If greater than 0.25, compare to 0.75. If greater than the low priority bit is 0 else the low priority bit is 1. So with probability 0.25, only 1 comparison is needed for the low priority bit also. This means that the expected number of comparisons for the low priority bit is:

0.25+0.75*2=1.75

This gives an expected read of the low priority bit in less than the current two comparisons. One of skill in the art will recognize other encodings and algorithms which can speed up reading of the low priority bit.

Systems and methods of the invention have been described above in terms of an MLC in which data is stored as one high priority bit and the remainder low priority bits. This is for illustration purposes and is not limiting. The principle can be extended to using any number of bits in the cell. Data from up to the total cell capacity sources can be stored in a cell (e.g., every bit can be a different priority).

In some embodiments, different files can get different numbers of bits. If multiple levels are desired, then it is possible for the most important files to get only the most significant bits, intermediate files to get the top two most significant bits (from different cells) and the least significant files to get whatever bits remain.

Unlike U.S. Publication 2012/0290768 to Rubowitz which does not specify the use of differential speeds for error correction, in some embodiments of the present invention, error correcting codes (ECC) are stored as low priority bits. This is advantageous because ECCs are typically not used that often since they are typically utilized when a failure actually occurs.

Any suitable algorithm for discovering the must accessed or highest priority data may be employed. Some such algorithms are known in paging and memory allocation. Such factors as the last read/access/write time, or knowledge of files such as OS related files can be employed. This information can be obtained via the OS or via bits on the file system which track data usage patterns (this information is already collected for use in leveling algorithms).

Currently, flash memory collects write patterns (for load leveling). One of the innovations of the invention is to collect read patterns in order to do write priority. It is also possible to make this decision in the OS, based on read data.

The write speed relates to the particular implementation of the invention. In some embodiments relating to hardware such as neuristors or NOR flash, the most significant bit can be written independently and hence the write speed remains the same or even increases.

According to the foregoing, it will be appreciated that the invention provides systems and methods for storing data from multiple sources within one MLC; allocating the bits of a cell so that a high level bit from a cell is read by a single comparator operation; designating ECC has low priority data; allocating the bits of an MLC to multiple, instead of a single, data source; optimizing flash memory read times; co-storing high and low priority bits within a cell; and other benefits. It is additionally noted that methods of the invention allocate high priority bits to the inherently more robust bit space of a cell, thereby decreasing the need for ECC. Read amounts can be collected (e.g., on an SSD) and used to allocate different speed space on the storage device (using usage patterns to determine bit allocation). Additionally, read patterns from an OS can be used for flash memory prioritization. Methods of the invention may include reading a cell to write a cell.

As used herein, the word “or” means “and or or”, sometimes seen or referred to as “and/or”, unless indicated otherwise.

Various modifications of the invention and many further embodiments thereof, in addition to those shown and described herein, will become apparent to those skilled in the art from the full contents of this document. The subject matter herein contains important information, exemplification and guidance that can be adapted to the practice of this invention in its various embodiments and equivalents thereof.

What is claimed is:

1. A device for storing information, the device comprising:
a bus comprising an interface for communication with a computer processor;
a plurality of storage cells operably connected to the bus;
a control system operably connected to the plurality of cells via the bus, wherein the control system is operable to store high priority information and low priority information in the plurality of cells and retrieve the high priority information by performing a single read operation simultaneously on each cell.

2. The device of claim 1, wherein the control system stores both high priority information and low priority information in each of the plurality of cells.

3. The device of claim 1, wherein the interface comprises a USB connector.

4. The device of claim 1, wherein the control system is operable to store the high priority information by reading the low priority information from the plurality of cells, then erasing the plurality of cells, and the store the high priority information and the low priority information in the plurality of cells.

5. The device of claim 1, wherein the control system stores the high priority information at one bit per cell in the plurality of cells.

6. The device of claim 1, wherein a number of duty cycles for a first set of bits is different from a number of duty cycles for a second set of bits within one of the plurality of storage cells.

7. The device of claim 1, wherein different voltages are used for bits of different priorities.

8. The device of claim 1, wherein different settling times are used for different bits.

9. The device of claim 1, wherein error correction bits are preferentially stored based on a speed of the reading of bits from the plurality of cells.

10. A method of storing data in a tangible medium, the method comprising:
receiving a set of bits;
storing each bit of the set of bits within a tangible storage medium in one of a plurality of cells; and
storing a second set of bits in the plurality of cells.

11. The method of claim 10, wherein the set of bits comprises part of a single digital file.

12. The method of claim 10, wherein the tangible storage medium comprises a solid state electronic device.

13. The method of claim 12, wherein each cell comprises a metal oxide field effect transistor.

14. The method of claim 10, further comprising obtaining the second set of bits from the plurality of cells and erasing the plurality of cells, wherein the obtaining and erasing steps occur after the receiving step and prior to the storing steps.

15. A method of writing to an array of multi-level cells, the method comprising:
receiving a plurality of high priority bit values;
reading a plurality of low-priority bit values stored as analog values in a plurality of cells;
encoding the high priority bit values and the low priority bit values as a plurality of new analog values; and
storing the plurality of new analog values in the plurality of cells with one high priority bit value per cell.

16. The method of claim 15, wherein a number of duty cycles for a first set of bits is different from a number of duty cycles for a second set of bits within at least one of the plurality of cells, and further wherein the method comprises continuing to write some bits within one of the plurality of cells after other bits are no longer usable.

17. The method of claim 15, wherein different voltages are used for bits of different priorities.

18. The method of claim 15, wherein different calibration and settlings times are used for different bits.

19. The method of claim 15, wherein error correction bits are preferentially stored based on a speed of reading of bits.
